(19) United States
(12) Patent Application Publication
(10) Pub. No.: US 2024/0409406 A1
(43) Pub. Date: Dec. 12, 2024

(54) METHOD FOR PRODUCING CRYSTALLIZED ALUMINUM HYDRIDE

(71) Applicant: BATTELLE SAVANNAH RIVER ALLIANCE, LLC, AIKEN, SC (US)

(72) Inventors: PATRICK A. WARD, AIKEN, SC (US); ELIEL VILLA-ALEMAN, AIKEN, SC (US)

(21) Appl. No.: 18/330,512

(22) Filed: Jun. 7, 2023

(51) Int. Cl. C01B 6/06; B01J 19/12

(52) U.S. Cl. CPC C01B 6/06; B01J 19/121; B01J 2219/00033; B01J 2219/0877; B01J 2219/12

(57) ABSTRACT

A method for producing alane is provided. The method comprises forming a solution comprising an alane adduct and a Lewis acid. The alane adduct comprises alane and a coordinating ligand. The method further comprises exposing the solution to a laser or high-power light at a at least one wavelength selected to cause dissociation of a bond between the alane and the coordinating ligand, resulting in crystallization of the alane and binding of the coordinating ligand to the Lewis acid after dissociation and separating the crystallized alane from the coordinating ligand and Lewis acid.

### STATEMENT REGARDING FEDERALLY SPONSORED RESEARCH OR DEVELOPMENT

This invention was made with Government support under Contract No. 89303321CEM00080, awarded by the U.S. Department of Energy. The Government has certain rights in the invention.

### BACKGROUND

Aluminum hydride, AlH₃, (also referred to as alane) has long been known as a useful reducing agent in organic synthesis. Alane forms numerous polymorphs, the most thermally stable of which and the form most sought after in industrial application being α-alane, which has a cubic or rhombohedral crystalline morphology. The potential for use of α-alane in hydrogen storage applications is especially attractive due to a theoretical gravimetric capacity of approximately 10 wt. %, a theoretical volumetric capacity of about 148 kg/m³ (0.148 g/cm³), and a desorption temperature starting above about 80° C., which provides an ability to release a substantial amount of hydrogen on demand. Such potential could be quite beneficial in solid phase storage of hydrogen for use as a fuel (for instance, in a fuel cell applications) and in solid energy applications (for instance, as a propellant).

Alane monomer is thermodynamically unstable and as a result, in order to obtain significant alane product, the monomer must be formed at high pressure or stabilized immediately upon formation. By use of a suitable electron donating solvent (e.g., diethyl ether or tetrahydrofuran), alane adduct can be formed to stabilize the nascent monomeric product. Following formation of the stable adduct, the alane must still be crystallized and passivated to provide the desired polymorph. Unfortunately, isolating the alane from other materials contained in the reaction mixture, including impurities, excess reactants, and the adduct complex partner itself, under conditions that crystallizes the desired alane phase in sufficient yield remains economically unfeasible, requires very precise control, and can also present safety issues. For example, the alane adduct can be decomposed into aluminum and flammable hydrogen gas if heated too much. These economic and safety issues have prevented the development of many potentially beneficial uses of alane.

The most widely used alane formation method today is the DOW process in which a low concentration solution of alane etherate in ether is slowly added to a heated benzene bath followed by ether evaporation to crystallize the alane. Unfortunately, this method can create many different alane phases in combination (α-alane, α′-alane, β-alane, γ-alane) as the addition of the low concentration solution to the crystallization temperature bath in conjunction with the evaporation of ether reduces the temperature in the bath, which leads to an impure product and necessitates suitable temperature control methodologies. The requirement of a low concentration alane etherate solution (to maintain the alane adduct in the liquid phase) also significantly limits batch size, increasing costs and production times.

In another approach, a slurry of a more highly concentrated mixture of toluene and alane etherate adduct is formed which reduces solvent requirements and increases processing speed but has significant safety barriers. Transfer of the slurry can clog lines, and the air-and shock-sensitivity of the adduct gives rise to hazardous conditions left over on reaction vessel walls when utilizing this slurry method. B

oth the above crystallization processes are batch processes.

As such, there is a need for an economical and safe method for formation of alane. For instance, a method that can provide a route for safe and fast crystallization of a high purity alane product (e.g., α-alane) from an alane adduct reaction mixture would be of great benefit. Additionally, it would be beneficial for such a method to be a continuous process.

### SUMMARY

In one aspect, a method for producing alane is provided. The method comprises forming a solution comprising an alane adduct and a Lewis acid. The alane adduct comprises alane and a coordinating ligand. The method further comprises exposing the solution to a laser or high-power monochromatic light at a at least one wavelength selected to cause dissociation of a bond between the alane and the coordinating ligand, resulting in crystallization of the alane and binding of the coordinating ligand to the Lewis acid after dissociation, and separating the crystallized alane from the coordinating ligand and Lewis acid.

In another embodiment, a continuous process for crystallizing alane is provided. The process comprises forming a solution comprising an alane adduct and a Lewis acid. The alane adduct comprises alane and a coordinating ligand. The method further comprises causing the solution to continuously flow through a reactor; exposing the solution to a laser or high-power monochromatic light at a at least one wavelength selected to cause dissociation of a bond between the alane and the coordinating ligand resulting in crystallization of the alane and binding of the coordinating ligand to the Lewis acid after dissociation, and continuously separating the crystallized alane from the coordinating ligand and Lewis acid.

In another embodiment, a method for producing alane is provided. The method comprises forming a solution comprising an alane adduct. The alane adduct comprises alane and a coordinating ligand. The method further comprises exposing the solution to a laser or high-power monochromatic light at a at least one wavelength selected to cause dissociation of a bond between the alane and the coordinating ligand, resulting in crystallization of the alane, and separating the crystallized alane from the coordinating ligand and Lewis acid.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to a process for crystallizing alane (i.e., aluminum hydride, AlH₃) from a solution containing an alane adduct. The process uses photodissociation to break the bond between the alane and a coordinating ligand in combination with an optional solvent binding compound to bind to the coordinating ligand to prevent reassociation of the coordinating ligand with the isolated alane. The process can be controlled to select for α-alane, which is the preferred polymorph, as it is stable over longer periods of time.

Advantageously, the disclosed process is adaptable to various alane adducts containing different coordinating ligands which were previously considered impractical due to the difficulty in isolating crystallized alane. As such, lower cost precursors, such as NaAlH₄, for forming the alane adduct can be used to produce the alane adduct. The lack of solubility of NaAlH₄ in diethyl ether previously limited its viability for direct alane adduct production without the assistance of ball milling or other agitative means.

Additionally, the process can be adapted to be run continuously, allowing for continuous production of isolated crystallized alane. Both these possibilities can greatly reduce the cost of producing alane, opening up more economically practical applications for alane use.

Various known methods exist for producing an alane adduct. For example, in one process, lithium aluminum hydride (LiAlH₄) is combined with aluminum chloride (AlCl₃) in a diethyl ether solvent, resulting in the formation of alane etherate and lithium chloride (LiCl). The precipitated lithium chloride is then filtered out, leaving a solution comprising alane etherate in a diethyl ether solvent. In such a process, the coordinating ligand is diethyl ether.

In another process, an alane adduct can be produced via electrolysis. For example, a complex hydride such as NaAlH₄ or KAlH₄ may be dissolved in the polar solvent tetrahydrofuran (THF) within an electrolytic cell containing a cathode (e.g., palladium) and an anode (e.g., aluminum). The alane will tend to accumulate on the anode as a solid adduct of alane and THF and can be filtered out. In some embodiments, the adduct can be dissolved in another solvent, such as triethylamine (TEA) or trimethylamine (TMA) to form an adduct of alane and TEA or TMA.

In the past, it was considered too difficult to separate the alane from the THF coordinating ligand since the temperature at which the adduct bond breaks is higher than the decomposition temperature for alane. However, by the photodissociation process described herein, it can be possible to directly dissociate the bond between the

THF ligand and the alane, as no heating is required. Alternatively, the process can also be used to produce alane from the resulting adduct of TEA or TMA in the case that either is exchanged with the THF ligand.

In another process, a mechanochemical solid/liquid reaction formation method can be utilized as described in U.S. Pat. No. 10,138, 122, which is incorporated herein by reference. According to this method, a solid phase alkali metal and an aluminum halide are reacted in the presence of a liquid phase Lewis base with the addition of energy obtained by use of a mechanical treatment via, e.g., a ball mill or the like. The mechanical treatment can provide energy that can encourage reaction between the solid reactants to form alane. The presence of the Lewis base can stabilize the alane as it is formed so as to provide the continuous formation of the alane adduct over the course of the alane formation process. In this process, the alane adduct comprises the alane and the Lewis base as a coordinating ligand.

The Lewis base can be a liquid at the conditions of the reaction and is capable of forming an adduct with the alane as it forms during the mechanochemical reaction. For instance, suitable Lewis bases can include ethers and amines such as, and without limitation, straight chain, branched, or cyclic alkyl ethers (e.g., diethyl ether, tetrahydrofuran, etc.), straight chain, branched or cyclic amines (e.g., ethyl amine, diethyl amine, tri-ethyl amines, tri-methyl amines, aniline, etc.), or combinations thereof. However, for this proves the Lewis base must be one that is in a liquid phase at the reaction conditions and within which the alkali metal containing reactant is insoluble at the reaction conditions.

Typically, in the mechanochemical process, sodium aluminum hydride (NaAlH₄) is used as the solid phase alkali metal, aluminum chloride is used as the aluminum halide, and the Lewis base is diethyl ether, as sodium aluminum hydride is insoluble in diethyl ether. In such a process, an alane etherate is formed as the alane adduct which can be dissociated by the process described herein.

By each of the processes described above, an alane adduct is formed comprising alane bonded to a coordinating ligand, which is typically a Lewis base. Traditionally the Lewis base is diethyl ether. However, other Lewis bases can also be used. For instance, suitable Lewis bases can include other ethers and amines such as, and without limitation, straight chain, branched, or cyclic alkyl ethers (e.g., tetrahydrofuran, etc.), straight chain, branched or cyclic amines (e.g., ethyl amine, diethyl amine, tri-ethyl amines, tri-methyl amines, aniline, etc.), or combinations thereof. Advantageously, the process described herein can be applied across a wide spectrum of such ether and amine adducts of alane.

Additionally, while various methods for forming an alane adduct are described above, the method for isolating and crystallizing the alane from the adduct is not dependent on the method for forming the adduct. Therefore, the process is applicable to any method which produces an adduct of alane and a coordinating ligand.

Table 1 below provides a list of possible alane adducts and their computationally predicted bond dissociation energies.

TABLE 1

| | Bond Dissociation |
|---|---|
| Adduct | Enthalpy (kJ/mol) |
| AlH3•Me2EtN | 110.27 |
| AlH3•Me2O | 85.40 |
| AlH3•Et2O | 74.90 |
| AlH3•Et2MeN | 73.13 |
| AlH3•2-MeTHF | 93.24 |
| AlH3•N-MeMorp_N | 97.03 |
| AlH3•IsoproMe2N | 92.35 |
| AlH3•THF | 94.94 |
| AlH3•Et3N | 98.23 |
| AlH3•DiisoproMeN | 87.51 |
| AlH3•EtButylO | 76.01 |
| AlH3•ProButylO | 76.26 |
| AlH3•MeButylO | 77.70 |
| AlH3•MTBE | 73.16 |
| AlH3•Pro2O | 77.41 |
| AlH3•Butyl2O | 77.45 |
| AlH3•MeProO | 81.18 |
| AlH3•MeEtO | 81.00 |

Once the alane adduct is formed, it is optionally combined with a Lewis acid, preferably a strong Lewis acid. For example, the Lewis acid can be added to a solution of the alane adduct in a Lewis base (e.g., alane etherate in diethyl ether, AlH₃:THF in THF, or AlH₃:TEA in TEA) where it acts to promote dissociation of the adduct bond or in a noncoordinating solvent (e.g., toluene, benzene, etc.) where it acts to isolate the coordinating ligand from the alane. Exemplary Lewis acids that can be used include boron trifluoride, boron tribromide, and borane. Preferably, a Lewis acid should be chosen for which the coordinating ligand has a stronger affinity for than alane. In some embodiments, the amount of the Lewis acid added is from about 1 vol. % to about 50 vol. % of the solution. The alane adduct can comprise from about 1 vol. % to about 50 vol. % of the solution. Optionally, a further solvent (e.g., toluene) may be added.

Additionally, in some embodiments, a polymerization catalyst, as is generally known in the art, can be present in the solution. For instance, a desolvating species can be included in the crystallization mixture as catalyst. Exemplary desolvating species can include, without limitation, a complex metal hydride (e.g., LiAl₄, LiBH₄, LiAlH₄, etc.) or a metal halide (e.g., LiCl). See, e.g., A. N. Tskhai et al. Rus. J. Inorg. Chem. 37:877 (1992), and U.S. Pat. No. 3,801,657 to Scruggs, which is incorporated herein by reference.

In order to isolate and crystallize the alane from the alane adduct, photodissociation of the bond between the alane and the coordinating ligand is employed. For example, in one embodiment, a laser or other high-power light source is directed at the solution at a specific wavelength or combination of wavelengths specifically selected to cause dissociation of the bond between the alane and the coordinating ligand. For example, a wavelength may be chosen that is associated with an electronic excitation in which the excited state disfavors the adduct bond. In another embodiment, the wavelength may be chosen which is associated with a vibrational mode of the adduct bond. In yet another embodiment, a quantum coherent control scheme can be employed to cause dissociation of the adduct bond. For example, a combination of wavelengths and timing can be used to selectively excite the alane adduct with one photon and then induce dissociation with a subsequent photon.

The specific wavelength(s) associated with adduct bond dissociation will vary with different coordinating ligands. For example, the wavelength must be such that an absorbed photon produces an excited state which disfavors the adduct bond or a multiphoton absorption scheme in which a vibration mode associated with the adduct bond can be targeted or a combination of the thereof. As such, the process can be adapted to a wide range of different adducts provided that the proper wavelength or coherent control scheme is selected to cleave the particular bond between the alane and the coordinating ligand.

The light source can be any monochromatic light source capable of emitting the selected wavelength. For example, a solid-state, liquid, semiconductor, or gas laser may be used as the light source. Pulsed lasers can be used in instances where peak power is desired and multiple wavelengths of photons are required. Typically, the light source will emit light in the visible or UV spectrum to dissociate the electronic states associated with adduct bonds and in the infrared to directly target vibrational modes.

As the light source is directed at the solution containing the alane adduct, the adduct bond is cleaved, separating the alane from the coordinating ligand. In some embodiments, the coordinating ligand can then be bound to the Lewis acid to prevent reassociation with the alane, leaving isolated crystallized alane, preferably α-alane. The crystallized alane can then be separated from the liquid phase containing the coordinating ligand and the Lewis acid. The Lewis acid and coordinating ligand are preferably separated from each other and can be recycled for reuse in the process. In other embodiments, the alane can be crystallized without the use of a Lewis acid.

In some embodiments, the process can be operated continuously. For example, the alane adduct can be continuously produced by known processes and then crystallized continuously. The crystallization process can be performed continuously by continuously forming a solution of the alane adduct and optionally the Lewis acid and causing it to continuously flow through a reactor (e.g., thin transparent tube) in which it is subjected to irradiation by the light source. The flowrate and path length of the solution can be controlled such that the residence time in the rector is sufficient to achieve a high yield of crystallized alane. After leaving the reactor, the crystallized alane can be continuously separated from the remaining solution components.

Following isolation and crystallization of the alane, preferably α-alane, the crystallized alane can be stabilized (i.e., passivated) for storage and transport. For instance, a weak acid solution (e.g., a 1% to 5% hydrochloric acid solution) may be added to the crystals such that the crystalized alane contacts the weak acid solution for a period of time to create an aluminum oxide coating on the surface of the alane, making it less reactive. Other mineral acids or buffered solutions of these acids may also be used in a passivation step, such as phosphoric acid (H₃PO₄), sulfuric acid (H₂SO₄), boric acid (H₃BO₃), hydrofluoric acid (HF), hydrobromic acid (HBr), hydroiodic acid (Hl), and mixtures thereof. Optionally, the crystallized alane can be introduced to an organic solvent such as toluene prior to adding the acid solution.

Following any passivation step, the produced alane may then be separated from the remaining materials and dried. Useful recovered materials can be reused, while other materials can be discarded as waste.

While certain embodiments of the disclosed subject matter have been described using specific terms, such description is for illustrative purposes only, and it is to be understood that changes and variations may be made without departing from the spirit or scope of the subject matter.

What is claimed is:

1. A method for producing alane, the method comprising:
forming a solution comprising an alane adduct and a Lewis acid, the alane adduct comprising alane and a coordinating ligand;
exposing the solution to a laser or high-power monochromatic light at a at least one wavelength selected to cause dissociation of a bond between the alane and the coordinating ligand, resulting in crystallization of the alane and binding of the coordinating ligand to the Lewis acid after dissociation; and
separating the crystallized alane from the coordinating ligand and Lewis acid.

2. The method of claim 1, wherein the coordinating ligand is a Lewis base.

3. The method of claim 2, wherein the Lewis base comprises ethyl amine, diethylamine, triethylamine, trimethylamine, aniline, or a combination thereof.

4. The method of claim 2, wherein the Lewis base comprises diethyl ether.

5. The method of claim 4, wherein the adduct is formed by combining lithium aluminum hydride, aluminum chloride, and diethyl either.

6. The method of claim 2, wherein the Lewis base comprises tetrahydrofuran.

7. The method of claim 6, wherein the adduct is formed by reaction of sodium aluminum hydride with aluminum chloride in a tetrahydrofuran solvent.

8. The method of claim 1, wherein the resulting crystallized alane comprises α-alane.

9. The method of claim 1, wherein the at least one wavelength is associated with a vibrational mode of the bond between the alane and the coordinating ligand.

10. The method of claim 1, wherein the at least one wavelength is associated with an electronic excitation of an electron which produces an excited state which disfavors the bond between the alane and the coordinating ligand.

11. The method of claim 1, wherein the at least one wavelength is applied by a laser pulse comprising a combination of wavelengths separated in time, at least one of which selectively excites the alane adduct and another which induces dissociation of the bond between the alane and the coordinating ligand.

12. The method of claim 1, wherein at least one wavelength is within the UV, visible, or infrared spectrum.

13. The method of claim 1, wherein the Lewis acid comprises of boron trifluoride, boron tribromide, borane, boron trichloride, boron triiodide, or a combination thereof.

14. The method of claim 1, further comprising separating the Lewis acid from the coordinating ligand by thermal dissociation and distillation.

15. A continuous process for crystallizing alane, the process comprising:
forming a solution comprising an alane adduct and a Lewis acid, the alane adduct comprising alane and a coordinating ligand;
causing the solution to continuously flow through a reactor;
exposing the solution to a laser or high-power monochromatic light at a at least one wavelength selected to cause dissociation of a bond between the alane and the coordinating ligand, resulting in crystallization of the alane and binding of the coordinating ligand to the Lewis acid after dissociation; and
continuously separating the crystallized alane from the coordinating ligand and Lewis acid.

16. The continuous process of claim 15, wherein the coordinating ligand comprises diethyl ether, tetrahydrofuran, ethyl amine, diethylamine, triethylamine, trimethylamine, aniline, or a combination thereof.

17. The method of claim 15, wherein the at least one wavelength is associated with a vibrational mode of the bond between the alane and the coordinating ligand or an electronic excitation of an electron which disfavors the bond between the alane and the coordinating ligand.

18. The method of claim 15, wherein the at least one wavelength is applied by a laser pulse comprising a combination of wavelengths separated in time, at least one of which selectively excites the alane adduct and another which induces dissociation of the bond between the alane and the coordinating ligand.

19. The method of claim 15, wherein the Lewis acid comprises of boron trifluoride, boron tribromide, borane, boron trichloride, boron triiodide, or a combination thereof.

20. A method for producing alane, the method comprising:
forming a solution comprising an alane adduct, the alane adduct comprising alane and a coordinating ligand;
exposing the solution to a laser or high-power monochromatic light at a at least one wavelength selected to cause dissociation of a bond between the alane and the coordinating ligand, resulting in crystallization of the alane; and
separating the crystallized alane from the coordinating ligand.
